(19) United States
(12) Patent Application Publication
(10) Pub. No.: US 2017/0193668 A1
(43) Pub. Date: Jul. 6, 2017

(54) Intelligent Equipment-Based Motion Sensing Control Method, Electronic Device and Intelligent Equipment

(71) Applicants: Le Holdings (Beijing) Co., Ltd., Beijing (CN); Lemobile Information Technology (Beijing) Co., Ltd., Beijing (CN)

(72) Inventor: Jianru Chen, Beijing (CN)

(73) Assignees: Le Holdings (Beijing) Co., Ltd., Beijing (CN); Lemobile Information Technology (Beijing) Co., Ltd., Beijing (CN)

(21) Appl. No.: 15/243,966

(22) Filed: Aug. 23, 2016

Related U.S. Application Data
(63) Continuation of application No. PCT/CN2016/088314, filed on Jul. 4, 2016.

(30) Foreign Application Priority Data
Dec. 31, 2015 (CN) 201511034014.6

(51) Int. Cl. G06T 7/20; G06T 7/60

(52) U.S. Cl. CPC G06T 7/2033; G06T 7/60; G06T 2207/10004; G06T 2207/30196

(57) ABSTRACT

The application discloses an intelligent equipment-based motion sensing control method, an electronic device, and intelligent equipment. The method includes the steps: collecting user image data; according to the user image data, acquiring an image contour of a user; according to the image contour, acquiring a first motion track of the user on an imaging plane; according to the change of a characteristic length on the image contour and/or the change of a focal distance of a camera, acquiring a second motion track of the user in a direction perpendicular to the imaging plane; and according to the first motion track and the second motion track, generating motion sensing data.

### CROSS REFERENCE TO RELATED APPLICATIONS

This application is a continuation of International Application No. PCT/CN2016/088314, filed on Jul. 4, 2016, which is based upon and claims priority to Chinese Patent Application No. 201511034014.6, filed on Dec. 31, 2015, titled “Intelligent Equipment-Based Motion Sensing Control Method and System, and Intelligent Equipment”, the entire contents of which are incorporated herein by reference.

### TECHNICAL FIELD

The application relates to the field of the computer vision technology, and particularly relates to an intelligent equipment-based motion sensing control method, an electronic device, and intelligent equipment.

### BACKGROUD

With the development of the computer vision technology, in the prior arts, a motion sensing game gradually enters people's lives. A motion sensing game machine operates a game by sensing the action of a human body through a motion sensing camera in comparison with the original mode of operating a game by a gamepad or a joystick, for example, an Xbox360 motion sensing game machine (Kinect) produced by Microsoft Corporation acquires the action of a human body through three motion sensing cameras and converts same into an operation instruction to control a game, so that people can obtain better operation experience when playing a game, and the human body can be exercised in a state of motion.

However, at present, some users are obstructed from experiencing a motion sensing game because the motion sensing camera is relatively expensive. Because the popularity of the intelligent equipment such as a smart cellphone, a tablet personal computer, etc. is very wide, if a camera on a smart cellphone can be used as a motion sensing camera, the application of the motion sensing technology such as a motion sensing game, etc. in people's lives will be greatly promoted.

### SUMMARY

The application provides an intelligent equipment-based motion sensing control method, an electronic device, and intelligent equipment for solving the problem that the application of the motion sensing technology in people's lives is obstructed because the motion sensing camera is expensive.

One objective of the embodiments of the application is to provide an intelligent equipment-based motion sensing control method, the intelligent equipment being provided with a camera, the method comprises collecting user image data; acquiring an image contour of a user, according to the user image data; acquiring a first motion track of the user on an imaging plane, according to the image contour; acquiring a second motion track of the user in a direction perpendicular to the imaging plane, according to the change of a characteristic length on the image contour and/or the change of a focal distance of the camera; and generating motion sensing data, according to the first motion track and the second motion track.

Preferably, the characteristic length comprises a hand contour length/width, a leg contour length/width or a head contour length/width.

Preferably, the method further comprises separating a user image from a foreground and a background, between the steps of collecting user image data and acquiring an image contour of a user according to the user image data.

Preferably, the method further comprises calibrating the second motion track, between the steps of acquiring a second motion track of the user in a direction perpendicular to the imaging plane according to the change of a characteristic length on the image contour and/or the change of a focal distance of the camera and generating motion sensing data according to the first motion track and the second motion track, according to the distance from each portion of the body of the user to the camera, which is obtained by the measurement of a distance measurement module.

Preferably, the distance measurement module is an infrared distance measurement module or a laser distance measurement module.

Another objective of the embodiments of the application is to provide intelligent equipment, comprising: a camera, used for collecting user image data; and a processor, used for acquiring an image contour of a user according to the user image data, acquiring a first motion track of the user on an imaging plane according to the image contour, acquiring a second motion track of the user in a direction perpendicular to the imaging plane according to the change of a characteristic length on the image contour and/or the change of a focal distance of the camera, and generating motion sensing data according to the first motion track and the second motion track.

Preferably, the processor is also used for receiving the distance, which is obtained by the measurement of an external distance measurement module, from each portion of the body of the user to the camera, and calibrating the second motion track according to the distance.

A further objective of the embodiments of the application is to provide an electronic device, comprising at least one processor; and a memory communicably connected with the at least one processor for storing instructions executable by the at least one processor, wherein, execution of the instructions by the at least one processor causes the at least one processor to collect user image data; acquire an image contour of a user according to the user image data; acquire a first motion track of the user on an imaging plane according to the image contour; acquire a second motion track of the user in a direction perpendicular to the imaging plane according to the change of a characteristic length on the image contour and/or the change of a focal distance of the camera; and generate motion sensing data according to the first motion track and the second motion track.

The electronic device, wherein, a user image is separated from a foreground and a background between the steps of collecting user image data and acquiring an image contour of a user according to the user image data.

The electronic device, wherein, the second motion track is calibrated between the steps of acquiring a second motion track of the user in a direction perpendicular to the imaging plane according to the change of a characteristic length on the image contour and/or the change of a focal distance of the camera and generating motion sensing data according to the first motion track and the second motion track, according to the distance from each portion of the body of the user to the camera, which is obtained by the measurement of a distance measurement module.

A further objective of the embodiments of the application is to provide a non-transitory computer-readable storage medium storing executable instructions that, when executed by an electronic device, cause the electronic device to: collect user image data; acquire an image contour of a user according to the user image data; acquire a first motion track of the user on an imaging plane according to the image contour; acquire a second motion track of the user in a direction perpendicular to the imaging plane according to the change of a characteristic length on the image contour and/or the change of a focal distance of the camera; and generate motion sensing data according to the first motion track and the second motion track.

Wherein, the characteristic length comprises a hand contour length/width, a leg contour length/width or a head contour length/width.

Wherein, between the steps of collecting user image data and acquiring an image contour of a user according to the user image data, further comprising: separating a user image from a foreground and a background.

Wherein, between the steps of acquiring a second motion track of the user in a direction perpendicular to the imaging plane according to the change of a characteristic length on the image contour and/or the change of a focal distance of the camera and generating motion sensing data according to the first motion track and the second motion track, further comprising: calibrating the second motion track according to the distance from each portion of the body of the user to the camera, which is obtained by the measurement of a distance measurement module.

Wherein, the distance measurement module is an infrared distance measurement module or a laser distance measurement module.

For the intelligent equipment-based motion sensing control method, the electronic device, and the intelligent equipment according to the embodiments of the application, only a camera on the intelligent equipment such as a smart cellphone, etc. is used to acquire user image data and obtain a first motion track of a user on an imaging plane and a second motion track in a direction perpendicular to the imaging plane according to the image data, thereby obtaining a motion track of the user in a three-dimensional space so as to generate motion sensing data, and therefore, the user can experience the motion sensing technology without additional equipment, which is beneficial to the popularization and application of the motion sensing technology.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a schematic diagram of an application scenario of intelligent equipment-based motion sensing control in accordance with the embodiments of the application;

FIG. 2 shows a flow diagram of an intelligent equipment-based motion sensing control method in accordance with the embodiments of the application;

FIG. 3 shows a schematic diagram of an intelligent equipment-based motion sensing control electronic device in accordance with the embodiments of the application;

FIG. 4 shows a schematic diagram of hardware configuration of an electronic device provided in the embodiments of the application.

### DETAILED DESCRIPTION

In order to clearly describe objectives, the technical solutions and advantages of the application, a clear and complete description of the technical solutions in the application will be given below, in conjunction with the accompanying drawings in the embodiments of the application. Apparently, the embodiments described below are a part, but not all, of the embodiments of the application.

The embodiments of the application will be described below in detail in conjunction with the accompanying drawings.

### Embodiment 1

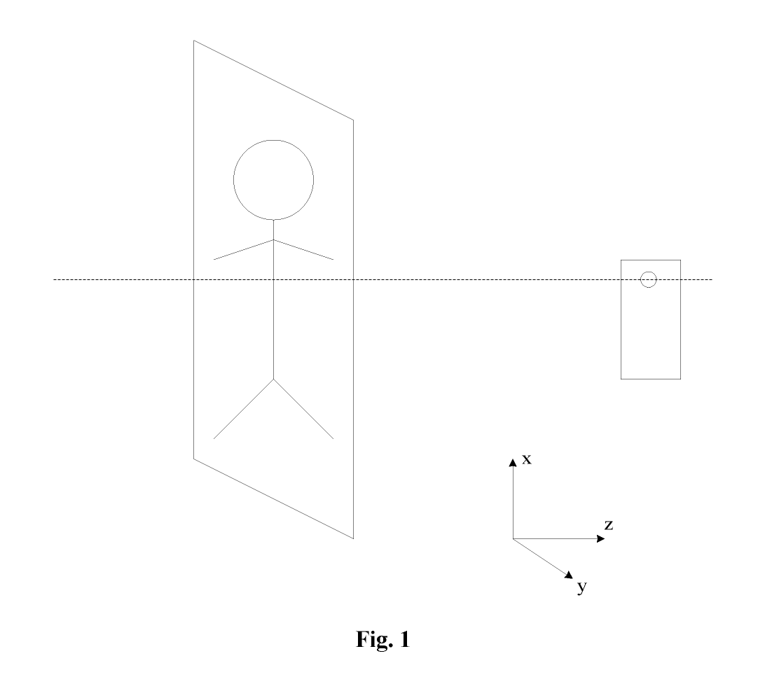

As shown in FIG. 1, for the intelligent equipment-based motion sensing control method according to the embodiments of the application, intelligent equipment which is provided with a camera is required, and the intelligent equipment can be a smart cellphone, a tablet personal computer, a laptop, etc. Preferably, a user needs to keep a certain distance from the camera of the intelligent equipment, so as to enable the camera to collect the image data of the whole body of the user. Of course, some motion sensing control only needs hand actions for control, and in this case, the camera only collects the image data of the hand of the user.

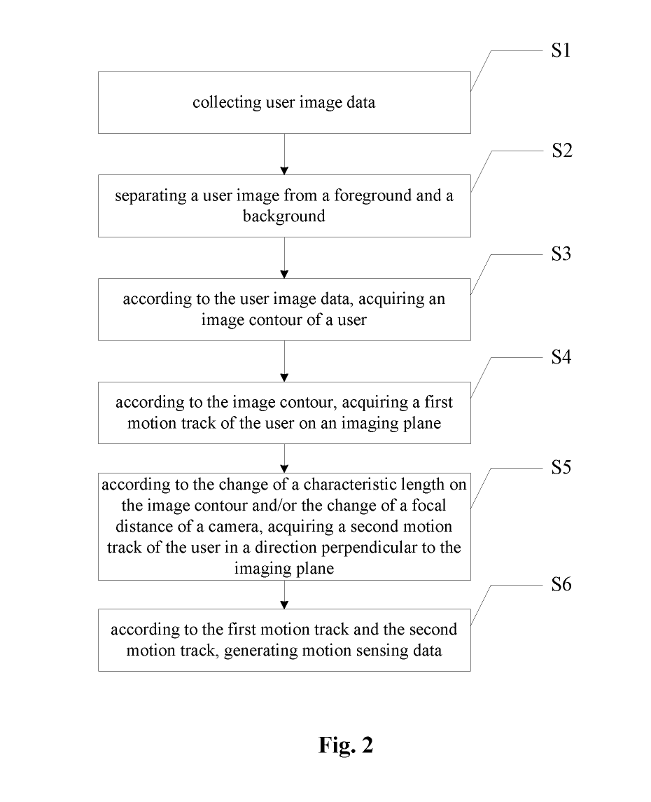

As shown in FIG. 2, the embodiments of the application provide an intelligent equipment-based motion sensing control method, the intelligent equipment being provided with a camera. The method comprises the following steps:

S1. collecting user image data. As shown in FIG. 1, the camera collects image data of a user on an imaging plane, i.e. an x-y plane.

S2. separating a user image from a foreground and a background. This step is an optional step, in this step, the user image can be separated from the foreground and the background by using any of the existing image separation methods, and therefore, the interference of the foreground and background images can be reduced, thereby reducing the computational load of the post processing of a processor.

S3. acquiring an image contour of the user according to the user image data. For motion sensing control, there is only a need to acquire a motion track of the body of the user, and therefore, there is no need to pay attention to other details of a user body image. The computational load of the post processing of the processor can be reduced by extracting the image contour.

S4. acquiring a first motion track of the user on the imaging plane according to the image contour. The image is collected in real time, so that according to the change of previous and next frame images, a first motion track of the user on the x-y plane can be obtained very easily.

S5. acquiring a second motion track of the user in a direction perpendicular to the imaging plane according to the change of a characteristic length on the image contour and/or the change of a focal distance of the camera. The shorter the distance from the user to the camera is, the larger the generated image is. Therefore, when the user moves towards the camera, the generated image may be gradually amplified, so that it can be judged that the user moves towards the camera according to the gradual increase of the characteristic length on the image contour. However, when the user moves away from the camera, the generated image may be gradually reduced, so that it can be judged that the user moves away from the camera according to the gradual reduction of the characteristic length on the image contour. The characteristic length can be a hand contour length/width, a leg contour length/width, a head contour length/width, etc., for example, it can be judged that the hand moves towards the camera when it is detected that the hand contour length/width is increased, and it can be judged that the hand moves away from the camera when it is detected that the hand contour length/width is reduced, so that the change of each trunk in a z direction can be judged. Meanwhile, when the user moves in the direction perpendicular to the imaging plane, i.e. the z direction, the camera can change a focal distance continuously to achieve clear imaging when capturing a user image, and therefore, it can be judged whether the user moves towards the camera or moves away from the camera according to the change of the focal distance of the camera. The motion track of the user in the direction perpendicular to the imaging plane can be judged in one of the two modes. Of course, in order to obtain a more accurate result, synthetic judgment can also be conducted according to the two modes, so as to obtain a more accurate result.

S6. generating motion sensing data according to the first motion track and the second motion track. A motion track of the user in a three-dimensional space can be obtained by combining the first motion track on the imaging plane with the second motion track in the direction perpendicular to the imaging plane, so that the motion sensing data can be obtained. The motion sensing data is input to a smart television or a computer having a motion sensing function, so that the user can experience a motion sensing game.

For the intelligent equipment-based motion sensing control method according to the embodiments of the application, only a camera on the intelligent equipment such as a smart cellphone, etc. is used to acquire user image data and obtain a first motion track of a user on an imaging plane and a second motion track in a direction perpendicular to the imaging plane according to the image data, thereby obtaining a motion track of the user in a three-dimensional space so as to generate motion sensing data, and therefore, the user can experience the motion sensing technology without additional equipment, which is beneficial to the popularization and application of the motion sensing technology.

The second motion track of the user in the direction perpendicular to the imaging plane is calculated according to the change of a characteristic length on the image contour and/or the change of a focal distance of the camera, which may be difficult to meet the requirements of some occasions requiring more accurate control, and therefore, it is necessary to correct the second motion track. For this reason, there is a need to add a distance measurement module so as to more accurately obtain the distance from the user to the camera in the z direction. The distance measurement module can be an infrared distance measurement module or a laser distance measurement module. The distance measurement module can be connected to the intelligent equipment such as a smart cellphone, etc. in a wired or wireless mode, so as to transmit the measured distance to the intelligent equipment. The intelligent equipment acquires the distance, which is obtained by the measurement of the distance measurement module, from each portion of the body of the user to the camera, corrects the second motion track according to the obtained distance, and finally generates more accurate motion sensing data according to the first motion track and the corrected second motion track.

### Embodiment 2

The embodiments of the application also provide an intelligent equipment-based motion sensing control system, the intelligent equipment being provided with a camera. The electronic device comprises: a collection unit 1 for collecting user image data; an image contour acquisition unit 3 for acquiring an image contour of a user according to the user image data; a first motion track unit 4 for acquiring a first motion track of the user on an imaging plane according to the image contour; a second motion track unit 5 for acquiring a second motion track of the user in a direction perpendicular to the imaging plane according to the change of a characteristic length on the image contour and/or the change of a focal distance of the camera, wherein preferably, the characteristic length comprises a hand contour length/width, a leg contour length/width or a head contour length/width; and a motion sensing data unit 7 for generating motion sensing data according to the first motion track and the second motion track.

For the intelligent equipment-based motion sensing control system according to the embodiments of the application, only a camera on the intelligent equipment such as a smart cellphone, etc. is used to acquire user image data and obtain a first motion track of a user on an imaging plane and a second motion track in a direction perpendicular to the imaging plane according to the image data, thereby obtaining a motion track of the user in a three-dimensional space so as to generate motion sensing data, and therefore, the user can experience the motion sensing technology without additional equipment, which is beneficial to the popularization and application of the motion sensing technology.

Preferably, the above-mentioned intelligent equipment-based motion sensing control system further comprises: a separation unit 2 for separating a user image from a foreground and a background between the steps of collecting, by the collection unit 1, user image data and acquiring, by the image contour acquisition unit 3, an image contour of a user according to the user image data. Therefore, the interference of the foreground and background images can be reduced, thereby reducing the computational load of the post processing of the processor.

Preferably, the above-mentioned intelligent equipment-based motion sensing control system further comprises: a correction unit 6 for calibrating the second motion track according to the distance, which is obtained by the measurement of a distance measurement module, from each portion of the body of the user to the camera between the steps of acquiring, by the second motion track unit 5, a second motion track of the user in a direction perpendicular to the imaging plane according to the change of a characteristic length on the image contour and/or the change of a focal distance of the camera and generating, by the motion sensing data unit 7, motion sensing data according to the first motion track and the second motion track. Preferably, the distance measurement module is an infrared distance measurement module or a laser distance measurement module. Therefore, more accurate motion sensing data can be obtained, thereby meeting the requirements of some occasions requiring more accurate control.

### Embodiment 3

The embodiments of the application provide a non-transitory computer-readable storage medium storing executable instructions that, when executed by an electronic device, cause the electronic device to: collect user image data, acquire an image contour of a user according to the user image data, acquire a first motion track of the user on an imaging plane according to the image contour, acquire a second motion track of the user in a direction perpendicular to the imaging plane according to the change of a characteristic length on the image contour and/or the change of a focal distance of the camera, and generate motion sensing data according to the first motion track and the second motion track.

As a preferred embodiment, the characteristic length comprises a hand contour length/width, a leg contour length/width or a head contour length/width.

As another preferred embodiment, between the steps of collecting user image data and acquiring an image contour of a user according to the user image data, further comprising: separating a user image from a foreground and a background.

As another preferred embodiment, between the steps of acquiring a second motion track of the user in a direction perpendicular to the imaging plane according to the change of a characteristic length on the image contour and/or the change of a focal distance of the camera and generating motion sensing data according to the first motion track and the second motion track, further comprising: calibrating the second motion track according to the distance from each portion of the body of the user to the camera, which is obtained by the measurement of a distance measurement module.

As another preferred embodiment, the distance measurement module is an infrared distance measurement module or a laser distance measurement module.

### Embodiment 4

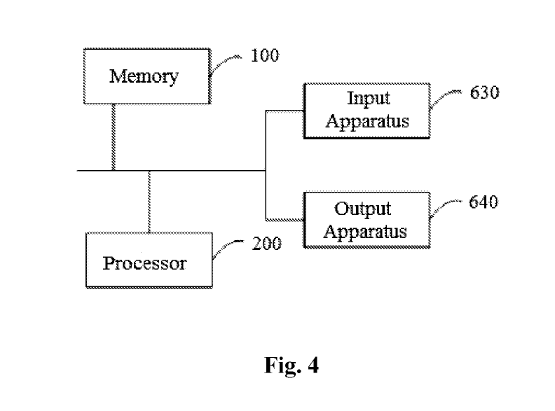

FIG. 4 is a schematic diagram of the hardware configuration of an electronic device provided by the embodiment of the application, which performs the intelligent equipment-based motion sensing control method. As shown in FIG. 4, the device includes: one or more processors 200 and a memory 100, wherein one processor 200 is shown in FIG. 4 as an example. The electronic device that performs the intelligent equipment-based motion sensing control method further includes an input apparatus 630 and an output apparatus 640.

The processor 200, the memory 100, the input apparatus 630 and the output apparatus 640 may be connected via a bus line or other means, wherein connection via a bus line is shown in FIG. 4 as an example.

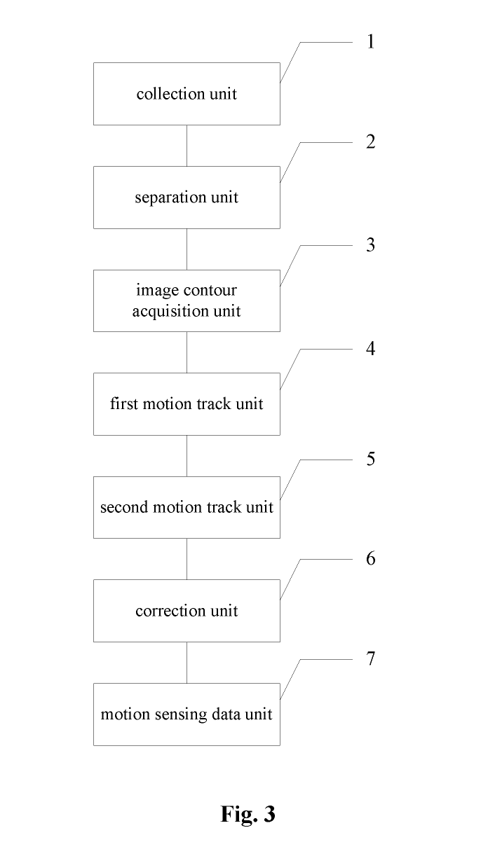

The memory 100 is a non-transitory computer-readable storage medium that can be used to store non-transitory software programs, non-transitory computer-executable programs and modules, such as the program instructions/modules corresponding to the intelligent equipment-based motion sensing control method of the embodiments of the application (e.g. a collection unit 1, a separation unit 2, an image contour acquisition unit 3, a first motion track unit 4, a second motion track unit 5, a correction unit 6 and a motion sensing data unit 7 shown in the FIG. 3). The processor 200 executes the non-transitory software programs, instructions and modules stored in the memory 100 so as to perform various function application and data processing of the server, thereby implementing the intelligent equipment-based motion sensing control method of the above-mentioned method embodiments

The memory 100 includes a program storage area and a data storage area, wherein, the program storage area can store an operation system and application programs required for at least one function; the data storage area can store data generated by use of the intelligent equipment-based motion sensing control system. Furthermore, the memory 100 may include a high-speed random access memory, and may also include a non-volatile memory, e.g. at least one magnetic disk memory unit, flash memory unit, or other non-volatile solid-state memory unit. In some embodiments, optionally, the memory 100 includes a remote memory accessed by the processor 200, and the remote memory is connected to the intelligent equipment-based motion sensing control system via network connection. Examples of the aforementioned network include but not limited to internet, intranet, LAN, GSM, and their combinations.

The input apparatus 630 receives digit or character information, so as to generate signal input related to the user configuration and function control of the intelligent equipment-based motion sensing control system. The output apparatus 640 includes display devices such as a display screen.

The one or more modules are stored in the memory 100 and, when executed by the one or more processors 200, perform the intelligent equipment-based motion sensing control method of any one of the above-mentioned method embodiments.

The above-mentioned product can perform the method provided by the embodiments of the application and have function modules as well as beneficial effects corresponding to the method. Those technical details not described in this embodiment can be known by referring to the method provided by the embodiments of the application.

The electronic device of the embodiments of the application can exist in many forms, including but not limited to:

(1) Mobile communication devices: The characteristic of this type of device is having a mobile communication function with a main goal of enabling voice and data communication. This type of terminal device includes: smartphones (such as iPhone), multimedia phones, feature phones, and low-end phones.

(2) Ultra-mobile personal computer devices: This type of device belongs to the category of personal computers that have computing and processing functions and usually also have mobile internet access features. This type of terminal device includes: PDA, MID, UMPC devices, such as iPad.

(3) Portable entertainment devices: This type of device is able to display and play multimedia contents. This type of terminal device includes: audio and video players (such as iPod), handheld game players, electronic books, intelligent toys, and portable GPS devices.

(4) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

(5) Other electronic equipments having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof

Finally, it should be noted that: The above-mentioned embodiments are merely illustrated for describing the technical scheme of the application, without restricting the technical scheme of the application. Although detailed description of the application is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the application.

1. An intelligent equipment-based motion sensing control method, the intelligent equipment being provided with a camera, comprising:
collecting user image data;
acquiring an image contour of a user, according to the user image data;
acquiring a first motion track of the user on an imaging plane, according to the image contour;
acquiring a second motion track of the user in a direction perpendicular to the imaging plane, according to the change of a characteristic length on the image contour and/or the change of a focal distance of the camera; and
generating motion sensing data, according to the first motion track and the second motion track.

2. The method according to claim 1, wherein, the characteristic length comprises a hand contour length/width, a leg contour length/width or a head contour length/width.

3. The method of claim 1, further comprising:
separating a user image from a foreground and a background, between the steps of collecting user image data and acquiring an image contour of a user according to the user image data.

4. The method according to claim 1, between the steps of acquiring a second motion track of the user in a direction perpendicular to the imaging plane according to the change of a characteristic length on the image contour and/or the change of a focal distance of the camera and generating motion sensing data according to the first motion track and the second motion track, further comprising:
calibrating the second motion track according to the distance from each portion of the body of the user to the camera, which is obtained by the measurement of a distance measurement module.

5. The method according to claim 4, wherein, the distance measurement module is an infrared distance measurement module or a laser distance measurement module.

6. An electronic device, comprising: at least one processor; and a memory communicably connected with the at least one processor for storing instructions executable by the at least one processor, wherein execution of the instructions by the at least one processor causes the at least one processor to:
collect user image data;
acquire an image contour of a user according to the user image data;
acquire a first motion track of the user on an imaging plane according to the image contour;
acquire a second motion track of the user in a direction perpendicular to the imaging plane according to the change of a characteristic length on the image contour and/or the change of a focal distance of the camera; and
generate motion sensing data according to the first motion track and the second motion track.

7. The electronic device according to claim 6, wherein, a user image is separated from a foreground and a background between the steps of collecting user image data and acquiring an image contour of a user according to the user image data.

8. The electronic device according to claim 6, wherein, the second motion track is calibrated between the steps of acquiring a second motion track of the user in a direction perpendicular to the imaging plane according to the change of a characteristic length on the image contour and/or the change of a focal distance of the camera and generating motion sensing data according to the first motion track and the second motion track, according to the distance from each portion of the body of the user to the camera, which is obtained by the measurement of a distance measurement module.

9. A non-transitory computer-readable storage medium storing executable instructions that, when executed by an electronic device, cause the electronic device to:
collect user image data;
acquire an image contour of a user according to the user image data;
acquire a first motion track of the user on an imaging plane according to the image contour;
acquire a second motion track of the user in a direction perpendicular to the imaging plane according to the change of a characteristic length on the image contour and/or the change of a focal distance of the camera; and
generate motion sensing data according to the first motion track and the second motion track.

10. The non-transitory computer-readable storage medium according to claim 9, wherein, the characteristic length comprises a hand contour length/width, a leg contour length/width or a head contour length/width.

11. The non-transitory computer-readable storage medium according to claim 9, wherein, between the steps of collecting user image data and acquiring an image contour of a user according to the user image data, further comprising:
separating a user image from a foreground and a background.

12. The non-transitory computer-readable storage medium according to claim 9, wherein, between the steps of acquiring a second motion track of the user in a direction perpendicular to the imaging plane according to the change of a characteristic length on the image contour and/or the change of a focal distance of the camera and generating motion sensing data according to the first motion track and the second motion track, further comprising:
calibrating the second motion track according to the distance from each portion of the body of the user to the camera, which is obtained by the measurement of a distance measurement module.

13. The non-transitory computer-readable storage medium according to claim 12, wherein, the distance measurement module is an infrared distance measurement module or a laser distance measurement module.
